(19) United States
(12) Patent Application Publication
(10) Pub. No.: US 2007/0280660 A1
(43) Pub. Date: Dec. 6, 2007

(54) Method for firing flash of image-capturing device

(75) Inventors: Jeff Yeh, Taipei (TW); Brian Fan, Taipei (TW)

Correspondence Address: TROXELL LAW OFFICE PLLC, SUITE 1404, 5205 LEESBURG PIKE, FALLS CHURCH, VA, 22041, US

(73) Assignee: Premier Image Technology Corp.

(21) Appl. No.: 11/583,950

(22) Filed: Oct. 20, 2006

(30) Foreign Application Priority Data
May 30, 2006 (TW) 095119098

(51) Int. Cl. G03B 15/03

(52) U.S. Cl. 396/61; 396/164

(57) ABSTRACT

A method for firing a flash of an image-capturing device is disclosed. The method uses a focus parameter, which is generated during the focusing procedure of the image-capturing device, to estimate a shooting distance. Then, the method dynamically determines a flash intensity of the flash according to the shooting distance, thereby obtaining improved exposure effect. In addition, since the preflash of the flash is skipped, the method can reduce the power consumption and shorten the shooting time, thereby enhancing the performance of the image-capturing device and the flash.

### BACKGROUND OF INVENTION

1. Field of the Invention

The present invention relates to image capturing, and more particularly to a method for firing a flash of an image-capturing device.

2. Description of the Prior Art

Generally, the image-capturing devices, such as digital cameras, often use flashes to provide complementary light sources during the image-capturing process. In some conventional cameras, the flash, when needed, is fired at a fixed intensity which cannot be adjusted according to the environment conditions. Thus, not only more electric power will be consumed, but also proper exposure compensation cannot be achieved due to the inability to adjust the flash intensity immediately.

In some advanced cameras, a preflash function is provided. Before the camera captures an image, it executes a preflash to feedback current environment brightness for determining the required intensity for a subsequent mainflash. However, the preflash would increase the power consumption of the battery and extend the shooting time of the image capturing, which results in the degradation of the performance for both the camera and the strobe.

Besides, when capturing a close-up image, the conventional camera usually fails to reduce the flash intensity correspondingly. Thus, the undesirable effect of over-exposure may often occur.

### SUMMARY OF INVENTION

It is therefore one object of the present invention to provide a method for firing a flash of an image-capturing device. This method can estimate a shooting distance according to a focusing parameter of the image-capturing device and dynamically determine a flash intensity according to the shooting distance, so as to obtain improved exposure compensation. For example, over-exposure can be avoided when a close-up image is captured. In addition, since the preflash of the flash is skipped, the electric power consumption is reduced and the shooting time is shortened. Thus, the performance of the image-capturing device and the flash can be enhanced.

Another object of the present invention is to provide a method for firing a flash of an image-capturing device. This method can execute different flash firing processes in response to different environment brightness, so as to enhance the performance of the image-capturing device and the flash.

According to one aspect of this invention, a method for firing a flash of an image-capturing device is provided. The method comprises the steps of: performing a focusing procedure of the image-capturing device to generate a focusing parameter; estimating a shooting distance according to the focusing parameter; determining a flash intensity for the flash according to the shooting distance; and firing the flash according to the flash intensity when the image-capturing device captures an image.

According to another aspect of this invention, a method for firing a flash of an image-capturing device is provided. The method comprises the steps of: detecting an environment brightness; determining whether the environment brightness reaches a predetermined brightness; executing a first firing process if the environment brightness reaches the predetermined brightness; and executing a second firing process if the environment brightness does not reach the predetermined brightness; wherein the first firing process comprises: performing a focusing procedure of the image-capturing device to generate a focusing parameter; estimating a shooting distance according to the focusing parameter; determining a flash intensity for the flash according to the shooting distance; and firing the flash according to the flash intensity when the image-capturing device captures an image.

### BRIEF DESCRIPTION OF THE DRAWINGS

FIG. 1 is a flowchart showing the steps of the method for firing a flash according to a first embodiment of the invention.

FIG. 2 is a flowchart showing the steps of the method for firing a flash according to a second embodiment of the invention.

FIG. 3 is a flowchart showing the steps of the method for firing a flash according to a third embodiment of the invention.

FIG. 4 is an example showing the corresponding relationship between flash intensity and shooting distance as well as zoom step.

FIG. 5 is a flowchart showing the steps of the method for firing a flash according to a fourth embodiment of the invention.

### DETAILED DESCRIPTION

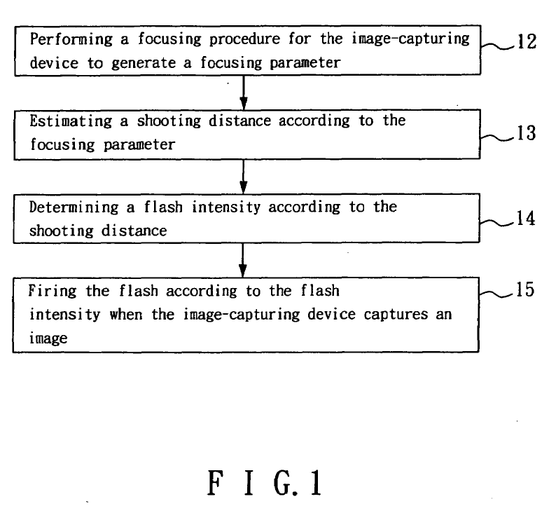

The embodiments described below are applicable to an image-capturing device, such as a digital camera, having a flash. FIG. 1 shows a flowchart of the method for firing a flash according to a first embodiment of the invention. The method contains the following steps:

Step 12: performing a focusing procedure for the image-capturing device to generate a focusing parameter;

Step 13: estimating a shooting distance according to the focusing parameter;

Step 14: determining a flash intensity according to the shooting distance; and

Step 15: firing the flash according to the flash intensity when the image-capturing device captures an image.

In step 12, the focusing procedure determines an optimum position for the focus lens of the image-capturing device, so as to obtain the optimum image resolution. The focusing parameter is generated during the focusing procedure and can be used in step 13 for estimating the shooting distance. In step 14, the longer the shooting distance is, the larger the determined flash intensity will be. On the contrary, the shorter the shooting distance, the less the determined flash intensity. Thus, the problem of over-exposure that occurs frequently when the image-capturing device carries out a close-up can be avoided.

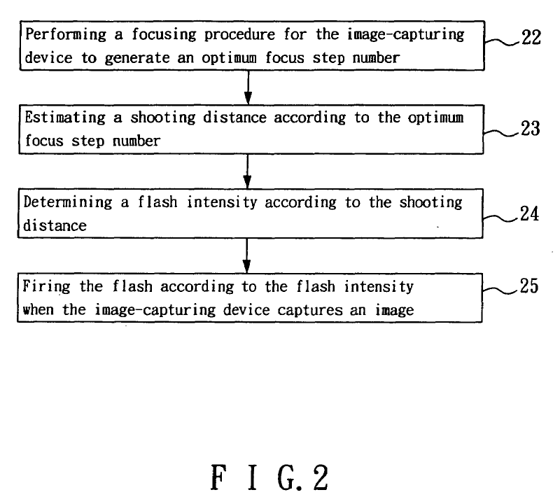

FIG. 2 is a flowchart showing the method for firing a flash according to a second embodiment of the invention. The method contains the following steps:

Step 22: performing a focusing procedure for the image-capturing device to generate an optimum focus step number;

Step 23: estimating a shooting distance according to the optimum focus step number;

Step 24: determining a flash intensity according to the shooting distance; and

Step 25: firing the flash according to the flash intensity when the image-capturing device captures an image.

In step 22, the focusing procedure moves the focus lens of the image-capturing device back and forth to a position that can be represented by a focus step number relative to a reference position. Afterwards, the light sensor, e.g. a charge coupled device (CCD), receives the light passing through the focus lens, and then the corresponding contrast value of the focus lens at the position is calculated. The above process would be repeated in the focusing procedure, so as to generate the contrast values of the focus lens at other positions. The larger the contrast value is, the better the image resolution will be. In other words, the focusing procedure is used to find an optimum position (or an optimum focus step number), where the largest contrast value can be generated. Furthermore, the optimum focus step number can be used to estimate the shooting distance in step 23. The manner for estimating the shooting distance according to the optimum focus step number is well known to people skilled in the art and would not be described in detail here.

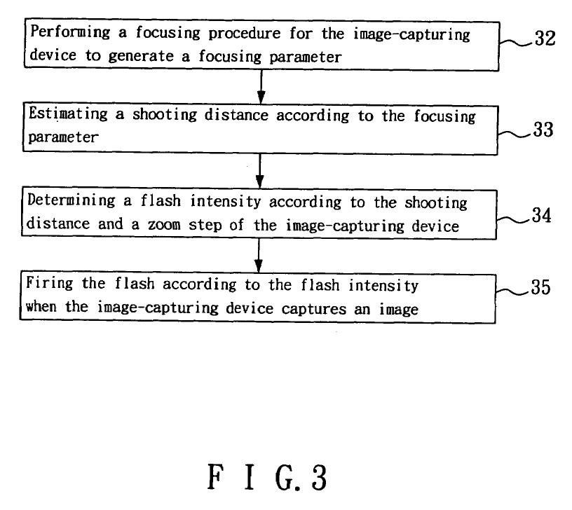

FIG. 3 shows a flowchart of the method for firing a flash according to a third embodiment of the invention. The method contains the following steps:

Step 32: performing a focusing procedure for the image-capturing device to generate a focusing parameter;

Step 33: estimating a shooting distance according to the focusing parameter;

Step 34: determining a flash intensity according to the shooting distance and a zoom step of the image-capturing device; and

Step 35: firing the flash according to the flash intensity when the image-capturing device captures an image.

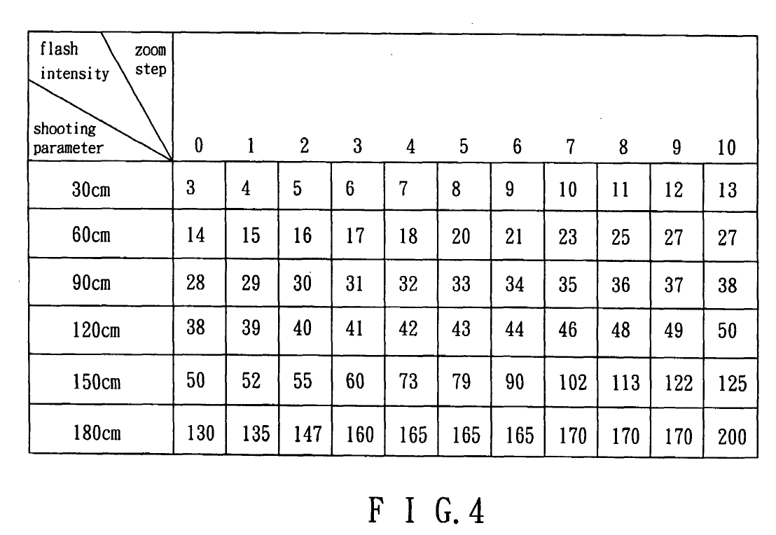

In the third embodiment, the flash intensity is determined according to both the shooting distance and the zoom step. FIG. 4 is a table showing an example of a corresponding relationship between the flash intensity and the shooting distance as well as the zoom step. The value in the table represents the required flash intensity at the specific zoom step and shooting distance. As shown in FIG. 4, the longer the shooting distance or the greater the zoom step (i.e. zoom in), the larger the required flash intensity. Conversely, the shorter the shooting distance or the less the zoom step (i.e. zoom out), the less the required flash intensity. Besides, the corresponding relationship between the flash intensity and the shooting distance as well as the zoom step is prerecorded in a memory of the image-capturing device. In this manner, the required flash intensity can be easily determined by accessing the memory during the image capturing process.

In a preferred embodiment, the influence of exposure parameter on the required flash intensity is also considered in addition to the shooting distance and zoom step. In this preferred embodiment, the exposure parameters, such as the aperture, the exposure value, the sensitivity (ISO), etc., can be adjusted according to the detected environment brightness. Moreover, an adjustment ratio can be generated according to the adjusted exposure parameters. The value of the flash intensity, which is determined according to the shooting distance and the zoom step and stored in the memory described in the third embodiment, is then multiplied by the adjustment ratio, so as to adjust the flash intensity in response to different exposure parameter values. In other words, in this preferred embodiment, the required flash intensity is determined according to the shooting distance, the zoom step and the exposure parameters.

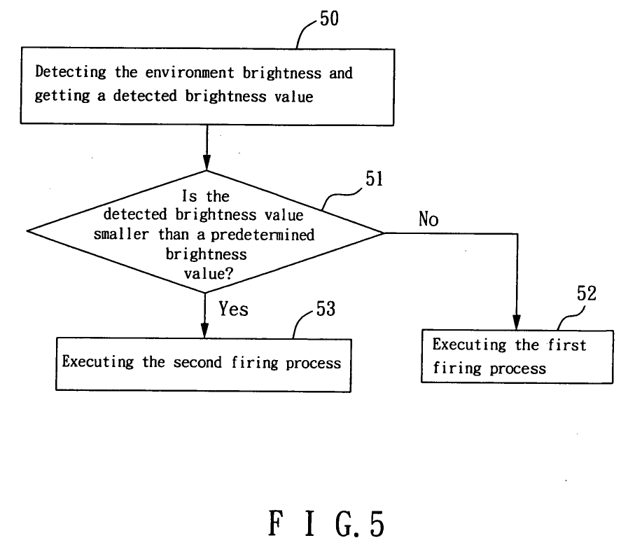

FIG. 5 is a flowchart showing the method for firing a flash according to a fourth embodiment of the invention. In the fourth embodiment, the environment brightness is detected firstly. After that, the firing process is selected according to the detected environment brightness. The firing processes may include the first firing process comprising steps 12 to 15 of the first embodiment and the second firing process comprising other flash firing method. That is, different firing process may be used for different environment brightness. The fourth embodiment provides more flexibility in determining the flash intensity of the flash. As shown in FIG. 5, this method contains the following steps:

Step 50: detecting the environment brightness and getting a detected brightness value;

Step 51: determining whether the detected brightness value is smaller than a predetermined brightness value; if yes, go to step 53; otherwise, go to step 52;

Step 52: executing the first firing process (i.e., steps 12 to 15 of the first embodiment) and stopping; and

Step 53: executing the second firing process.

In step 51, the predetermined brightness value varies with different image-capturing devices. When the detected brightness value is smaller than the predetermined brightness value, it means the environment brightness is too dark for the focusing procedure to generate the focusing parameter. Therefore, the first firing process is not applicable under such a condition and the second firing process will be executed to fire the flash.

In step 53, the second firing process may actuate a focus illuminator when the focusing procedure is performed. After that, a suitable flash intensity may be concluded for the main flash of the image capturing. In another embodiment, the second firing process may also execute a preflash to determine the flash intensity of the main flash.

While the present invention has been shown and described with reference to the preferred embodiments thereof and in terms of the illustrative drawings, it should not be considered as limited thereby. Various possible modifications and alterations could be conceived of by one skilled in the art for the form and the content of any particular embodiment, without departing from the scope and the spirit of the present invention.

What is claimed is:

1. A method for firing a flash of an image-capturing device, comprising steps of:
performing a focusing procedure of the image-capturing device to generate a focusing parameter;
estimating a shooting distance according to the focusing parameter;
determining a flash intensity for the flash according to the shooting distance; and
firing the flash according to the flash intensity when the image-capturing device captures an image.

2. The method according to claim 1, wherein the focusing parameter is an optimum focus step number.

3. The method according to claim 1, wherein the flash intensity is determined by the shooting distance and a zoom step of the image-capturing device.

4. The method according to claim 3, wherein a corresponding relationship between the flash intensity and the shooting distance as well as the zoom step is prerecorded in the image-capturing device.

5. The method according to claim 4, further comprising:
adjusting the flash intensity according to the corresponding relationship and an adjustment ratio;
wherein the adjustment ratio is determined according to an exposure parameter of the image-capturing device.

6. The method according to claim 3, wherein the flash intensity is determined according to the shooting distance, the zoom step and an exposure parameter of the image-capturing device.

7. The method according to claim 1, wherein the flash intensity is determined according to the shooting distance and an exposure parameter of the image-capturing device.

8. The method according to claim 1, further comprising:
detecting an environment brightness prior to performing the focusing procedure; and
activating a focus illuminator if the environment brightness does not reach a predetermined brightness.

9. A method for firing a flash of an image-capturing device, comprising steps of:
detecting an environment brightness;
determining whether the environment brightness reaches a predetermined brightness;
executing a first firing process if the environment brightness reaches the predetermined brightness; and
executing a second firing process if the environment brightness does not reach the predetermined brightness;
wherein the first firing process comprises:
performing a focusing procedure of the image-capturing device to generate a focusing parameter;
estimating a shooting distance according to the focusing parameter;
determining a flash intensity for the flash according to the shooting distance; and
firing the flash according to the flash intensity when the image-capturing device captures an image.

10. The method according to claim 9, wherein the second firing process comprises:
executing a preflash of the flash to determine a flash intensity for the flash; and
executing a mainflash of the flash according to the flash intensity when the image-capturing device captures an image.

11. The method according to claim 9, wherein the second firing process comprises:
actuating a focus illuminator and executing a focusing procedure of the image-capturing device to generate a focusing parameter;
estimating a shooting distance according to the focusing parameter;
determining a flash intensity for the flash according to the shooting distance; and
firing the flash according to the flash intensity when the image-capturing device captures an image.

12. The method according to claim 9, wherein the focusing parameter is an optimum focus step number.

13. The method according to claim 9, wherein the flash intensity is determined according to the shooting distance and a zoom step of the image-capturing device.

14. The method according to claim 13, wherein a corresponding relationship between the flash intensity and the shooting distance as well as the zoom step is prerecorded in the image-capturing device.

15. The method according to claim 14, further comprising:
adjusting the flash intensity according to the corresponding relationship and an adjustment ratio;
wherein the adjustment ratio is determined according to an exposure parameter of the image-capturing device.

16. The method according to claim 13, wherein the flash intensity is determined according to the shooting distance, the zoom step and an exposure parameter of the image-capturing device.

17. The method according to claim 9, wherein the flash intensity is determined according to the shooting distance and an exposure parameter of the image-capturing device.

18. The method according to claim 15, wherein the exposure parameter is adjusted according to the detected environment brightness.

19. The method according to claim 16, wherein the exposure parameter is adjusted according to the detected environment brightness.

20. The method according to claim 17, wherein the exposure parameter is adjusted according to the detected environment brightness.
